(19) United States
(12) Patent Application Publication
(10) Pub. No.: US 2016/0137021 A1
(43) Pub. Date: May 19, 2016

(54) VEHICLE AIR-CONDITIONING DEVICE, VEHICLE AIR-CONDITIONING HEATER, AND VEHICLE AIR-CONDITIONING METHOD

(71) Applicant: MITSUBISHI HEAVY INDUSTRIES AUTOMOTIVE THERMAL SYSTEMS CO., LTD., Kiyosu-shi, Aichi (JP)

(72) Inventors: Masatosi MORISITA, Minato-ku, Tokyo (JP); Koji NAKANO, Minato-ku, Tokyo (JP); Hideo NAKAMURA, Minato-ku, Tokyo (JP); Keiji NAGASAKA, Minato-ku, Tokyo (JP); Shunsuke YAKUSHIJI, Minato-ku, Tokyo (JP)

(73) Assignee: MITSUBISHI HEAVY INDUSTRIES AUTOMOTIVE THERMAL SYSTEMS CO., LTD., Kiyosu-shi, Aichi (JP)

(21) Appl. No.: 14/902,155

(22) PCT Filed: Aug. 11, 2014
(86) PCT No.: PCT/JP2014/071171

§ 371 Date: Dec. 30, 2015

(30) Foreign Application Priority Data
Sep. 20, 2013 (JP) 2013-195311

(51) Int. Cl. B60H 1/00

(52) U.S. Cl. CPC B60H 1/00007; B60H 1/00428

(57) ABSTRACT

The purpose of the present invention is to integrate a heating air-conditioning configuration and a cooling system of a vehicle, to enable more efficient heating air conditioning. A vehicle air-conditioning device is provided with: a radiator used for cooling a vehicle-side heat-generating apparatus; a heater core that exchanges heat between a coolant and air to be blown into a vehicle cabin; and coolant passages through which the coolant flows so as to be circulated between the heater core and the radiator. Furthermore, the vehicle air-conditioning device is provided with a water heater which is integrated with a power element for air conditioning formed of a semiconductor element with high heat resistance and which causes the power element and a heat-generating body to heat the coolant flowing to the heater core.

### TECHNICAL FIELD

The present invention relates to a vehicle air-conditioning device, a vehicle air-conditioning heater, and a vehicle air-conditioning method.

### BACKGROUND ART

In hybrid electric vehicles (HEV) or in plug-in hybrid electric vehicles (PHEV), there are various types of equipment such as a direct current power supply and inverter, a motor driven by the inverter, and the like, in addition to the engine that is the internal combustion engine.

In such vehicles, it is necessary to cool not only the engine, but also the vehicle inverter which includes a power element, and this cooling system is independent. Also, in electric vehicles (EV) that do not require an engine, the cooling system for inverter and the water heater system for cabin heating are independent of each other. When the cooling system is independent, the number of components is increased, and the cost is increased.

Note that the upper temperature limit of the cooling water of the inverter is determined by thermal loss of the semiconductor (silicon: Si) that forms the power element, heat resistance, a cooling structure, and the like. In the case of a normal power element formed from Si, it is necessary to suppress a rise in temperature up to about 65° C., for example.

In Patent Document 1, an inverter device formed of an SiC power element made from silicon carbide (SiC) that has heat resistance at the cooling water temperature when cooling the engine in an HEV cooling system is disclosed. Also, in the cooling system, the inverter device is arranged in series with the engine, and the engine cooling water is used for cooling the inverter device. In this way in Patent Document 1, a configuration is disclosed in which the inverter formed of an SiC power element (hereafter referred to as “SiC inverter”) and the engine cooling system are integrated and cooled by the same radiator.

Also, when the external air temperature is low, the resistance to the cranking drive power is increased as a result of an increase in the oil viscosity within the engine, so the engine starting properties become poor. In Patent Document 1, improvement in the engine start-up performance by using the heat generated from the SiC inverter is disclosed.

### CITATION LIST

### Patent Literature

Patent Document 1: Japanese Patent No. 4140562B

### SUMMARY OF INVENTION

### Technical Problem

Normally an HEV or PHEV is controlled so that, during idling, the engine is stopped as much as possible in order to improve the fuel economy. However, because the engine exhaust heat is used as the heat source for air-conditioning, it is not possible to stop the engine when the external air temperature is low and cabin heating is being used.

In Patent Document 1, although the SiC inverter is cooled by the engine cooling system, it is not stated that the heat produced by the SiC inverter is used for air-conditioning.

In view of the above, an object of the present invention is to provide a vehicle air-conditioning device, vehicle air-conditioning heater, and vehicle air-conditioning method that integrate a cooling system of the vehicle and a heating air-conditioning configuration, to enable more efficient heating air conditioning.

### Solution to Problem

In order to solve the above problem, the vehicle air-conditioning device, the vehicle air-conditioning heater, and the vehicle air-conditioning method adopt the following means.

The vehicle air-conditioning device according to a first aspect of the present invention includes: a radiator used for cooling a vehicle-side heat-generating apparatus; a heater core that exchanges heat between air that is to be blown into a vehicle cabin and a heating medium; a passage through which the heating medium flows so as to be circulated between the radiator and the heater core; and a heater integrated with a power element for air conditioning formed of a semiconductor element with high heat resistance, the heater being configured to cause the power element and a heat-generating body to heat the heating medium that flows to the heater core.

According to this configuration, the heater core exchanges heat between the air that is to be blown into the vehicle cabin and the heating medium. The interior of the vehicle cabin is heated by the air that has been subjected to the heat exchange.

The heating medium flows through the passage and circulates between the radiator used for cooling the vehicle-side heat-generating apparatus and the heater core. In other words, after cooling the vehicle-side heat-generating apparatus, the heat of the heating medium is dissipated in the radiator, and then is introduced to the heater core. In this way, in this configuration, the cooling system of the vehicle-side heat-generating apparatus and the heating system of the vehicle air-conditioning device are integrated. Note that the vehicle-side heat-generating apparatus is, for example, an engine for driving the vehicle, an inverter, a motor, a battery, or the like.

The heating medium that flows to the heater core is heated by the heater. The heater is integrated with a power element for air conditioning formed of a semiconductor element with high heat resistance. The heater causes the power element and a heat-generating body to heat the heating medium.

Note that the high heat resistance semiconductor element is, for example, SiC. By forming the power element using a semiconductor element with high heat resistance, the power element has resistance to the heating medium that is heated to a high temperature by cooling the engine, and the heating medium can be further heated by the heat generated by the semiconductor element with high heat resistance itself. Also, the semiconductor element with high heat resistance, in other words the power element, is cooled by the heating medium as the heating medium is heated. Therefore, in this configuration, the air-conditioning power element is cooled by the cooling system of the vehicle-side heat-generating apparatus, and the heat thereof is used for heating air conditioning.

Also, the air-conditioning power element and the heat-generating body are integrated to form the water heater. Therefore, the electrical power of the heat-generating body necessary to heat the heating medium is reduced compared with the conventional technology, and the load on the heat-generating body is reduced, so the reliability of the heater is increased. On the other hand, the heat-generating body supplements the amount of heating which is insufficient with the air-conditioning power element alone, so there is always sufficient heating for the heating medium. In this way, the air-conditioning power element and the heat-generating body complement each other, so the heater can more efficiently heat the heating medium.

In this way, the present configuration integrates the heating air-conditioning configuration and the cooling system of the vehicle, to enable more efficient heating air conditioning.

In the first aspect as described above, preferably the passage includes a bypass passage that causes the heating medium to bypass the vehicle-side heat-generating apparatus and the radiator and to be delivered to the heater.

According to this configuration, bypassing the vehicle-side heat-generating apparatus and the radiator allows the heating medium that has been heated by the heater to be fed to the heater core in priority. In this way, the temperature of the heating medium can be raised in a short period of time, and the start-up performance of the heating is improved.

In the first aspect as described above, preferably the heater heats the heating medium whose heat has been dissipated in the radiator before the heating medium is delivered to the heater core.

According to this configuration, control of the temperature of the heating medium is simplified, and control of the temperature of the heating is easy.

In the first aspect as described above, preferably the heater can be operated by electrical power from an electrical power source that is external to the vehicle.

According to this configuration, heating the vehicle cabin can be carried out with the heater in advance before a person enters the vehicle, thereby improving the comfort of the occupant.

The vehicle air-conditioning heater according to a second aspect of the present invention includes: a heat-generating body; and an air-conditioning power element formed of a semiconductor element with high heat resistance. The heat-generating medium and the power element are disposed facing each other and in contact with a passage through which a heating medium for heating air-conditioning flows.

The vehicle air-conditioning method according to a third aspect of the present invention is for a vehicle that includes a radiator used for cooling a vehicle-side heat-generating apparatus, a heater core that exchanges heat between air to be blown into a vehicle cabin and a heating medium, and a passage through which the heating medium flows so as to be circulated between the radiator and the heater core. The method includes: heating the heating medium flowing to the heater core by a power element for air conditioning formed of a semiconductor element with high heat resistance and a heat-generating body.

### Advantageous Effects of Invention

According to the present invention, the cooling system of a vehicle and the heating air-conditioning configuration are integrated, to enable more efficient heating air conditioning.

### BRIEF DESCRIPTION OF DRAWINGS

FIG. 1 illustrates a configuration of a vehicle air-conditioning device in an embodiment of the present invention;

FIG. 2 is a cross-sectional view of a water heater in the embodiment of the present invention;

FIG. 3 is a cross-sectional view of a multi-layered water heater in the embodiment of the present invention;

FIG. 4 illustrates the coolant flow in normal heating operation of the vehicle air-conditioning device in the embodiment of the present invention;

FIG. 5 illustrates illustrates the coolant flow in bypass heating operation of the vehicle air-conditioning device in the embodiment of the present invention;

FIG. 6 illustrates a configuration of a vehicle air-conditioning device in a first modified example of the present invention; and

FIG. 7 illustrates a configuration of a vehicle air-conditioning device in a second modified example of the present invention.

### DESCRIPTION OF EMBODIMENTS

An embodiment of the vehicle air-conditioning device, vehicle air-conditioning heater, and vehicle air-conditioning method according to an embodiment of the present invention is described below with reference to the accompanying drawings.

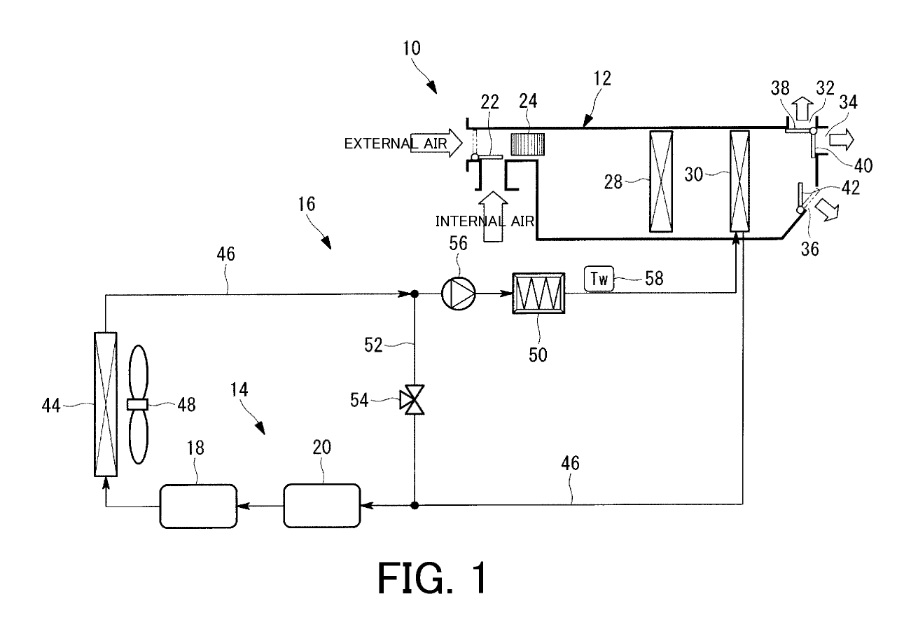

FIG. 1 illustrates a configuration of a vehicle air-conditioning device 10 according to the present embodiment.

The vehicle air-conditioning device 10 according to the present embodiment is mounted in a hybrid electric vehicle (HEV) or in a plug-in hybrid electric vehicle (PHEV).

Also, as described in detail later, in the vehicle air-conditioning device 10, a heating ventilation and air-conditioning unit (HVAC unit) 12 is integrated with a cooling system 16 of a vehicle-side heat-generating apparatus 14. The vehicle-side heat-generating apparatus 14 is, for example, an engine 18 for driving the vehicle (internal combustion engine), an inverter 20, a motor, a battery, and the like.

The HVAC unit 12 includes a blower 24 that introduces internal air from within the vehicle cabin or external air from outside the vehicle cabin that is switched by an internal and external air switching damper 22 and delivers the air under pressure to the downstream side, and a vehicle cabin evaporator 28 and a heater core 30 disposed in that order from the upstream side toward the downstream side within an air flow channel 26 that is connected to the blower 24. The vehicle air-conditioning device 10 is disposed within the instrument panel on the vehicle cabin side, and blows out air whose temperature has been adjusted by the vehicle cabin evaporator 28 and the heater core 30 from a plurality of defrosting outlets 32, face outlets 34, and foot outlets 36 that open into the vehicle cabin. Also, the air is blown into the vehicle cabin in accordance with a blow out mode that is selectively switched by blow out mode switching dampers 38, 40, 42, so that the vehicle cabin is air-conditioned to the set temperature.

The vehicle cabin evaporator 28 exchanges heat between the air that is to be blown into the vehicle cabin and a refrigerant. The air that is cooled by this heat exchange is blown into the vehicle cabin from any of the defrosting outlets 32, face outlets 34, and foot outlets 36 in accordance with the blow out mode that is switched by the blow out mode switching dampers 38, 40, 42, to cool the interior of the vehicle cabin. Note that in FIG. 1, a refrigerant circuit connected to the vehicle cabin evaporator 28 is omitted.

The heater core 30 exchanges heat between the air that is to be blown into the vehicle cabin and a heating medium. The air that is heated by this heat exchange is blown into the vehicle cabin from any of the defrosting outlets 32, face outlets 34, and foot outlets 36 in accordance with the blow out mode that is switched by the blow out mode switching dampers 38, 40, 42, to heat the interior of the vehicle cabin. In the following description, the heating medium is referred to as coolant.

The heater core 30 is connected to a passage (hereafter referred to as “coolant passage”) 46 through which the coolant is circulated between a radiator 44 used for cooling the vehicle-side heat-generating apparatus 14 and the heater core 30.

External air is passed through the radiator 44 by a vehicle cabin exterior fan 48, to dissipate the heat of the coolant after cooling the vehicle-side heat-generating apparatus 14.

Also, the coolant passage 46 includes a heater (hereafter referred to as “water heater”) 50 that is integrated with an air-conditioning power element formed of a semiconductor element with high heat resistance, and that heats the coolant with the power element and a heat-generating body.

In other words, the coolant that flows to the heater core 30 is heated by the water heater 50. In this way, the cooling system 16 of the vehicle-side heat-generating apparatus 14 and the heating system of the vehicle air-conditioning device 10 are integrated.

Note that the air-conditioning power element is provided in, for example, an air conditioning inverter.

The semiconductor element with high heat resistance forming the power element is a semiconductor element with heat resistance higher than a conventional Si semiconductor element or the like. Also, as described in detail later, the semiconductor element with high heat resistance may be an element that is capable of withstanding the rise in temperature of the coolant flowing through the coolant passage 46.

One example of semiconductor element with high heat resistance is SiC, but this is not a limitation, and the semiconductor may be a gallium nitride or a diamond semiconductor.

Note that preferably the semiconductor element used in the inverter 20 for driving the vehicle is also a semiconductor element with high heat resistance such as SiC.

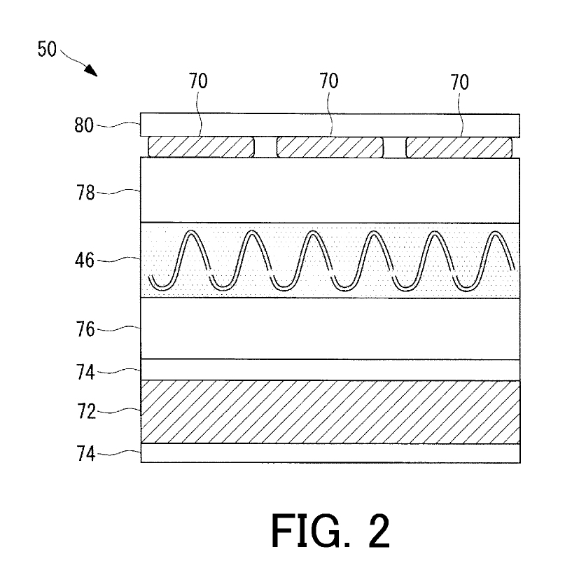

FIG. 2 is a cross-sectional view of the water heater 50 according to the present embodiment. Note that the configuration of the water heater 50 illustrated in FIG. 2 is one example, and the water heater 50 is not limited thereto.

As described above, the water heater 50 includes an air-conditioning power element 70 formed of SiC and a heat-generating body. Also, the coolant passage 46 at the location where the water heater 50 is disposed serves as a heat exchanger that heats the coolant by a positive temperature coefficient (PTC) element 72 that is a heat-generating body and the power element 70 being disposed facing each other and in contact with the coolant passage 46.

The PTC element 72 is one example of heat-generating body according to the present embodiment, but this is not a limitation, and other types of heat-generating body may be used. Also, contact as mentioned here may be either direct contact or indirect contact.

In an example of the water heater 50 according to the present embodiment, the PTC element 72 sandwiched between electrode plates 74 is in contact with the coolant passage 46 with an insulating heat-conductive sheet 76 disposed therebetween. Then a case 78 (for example, an aluminum case) that houses the power element 70 so that the power element 70 faces the PTC element 72 is in contact with the coolant passage 46. A control substrate 80 is disposed above the power element 70.

In other words, the heat from the PTC element 72 is transferred to the coolant via the electrode plate 74 and the heat-conductive sheet 76. Also, the heat from the PTC element 70 is transferred to the coolant via the case 78.

Note that when a copper inlay substrate or a heat dissipating substrate is used as the control substrate 80, the control substrate 80 is disposed below the power element 70 and in contact with the case 78. In other words, the heat from the PTC element 70 is transferred to the coolant via the control substrate 80 and the case 78.

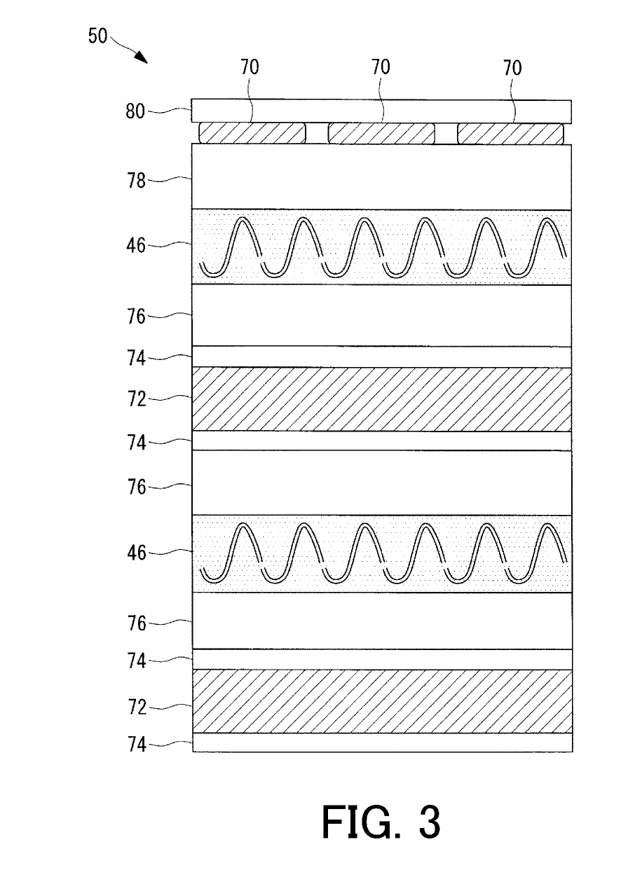

In addition, in order to further increase the heat exchange efficiency, preferably the water heater 50 is multi-layered as illustrated in FIG. 3.

In the multi-layered water heater 50, a plurality of PTC elements 72 are provided, and the coolant is heated by bringing the PTC element 72 into contact with each of the branched coolant passages 46 with the heat-conductive sheet 76 disposed therebetween. Note that the PTC element 72 that is sandwiched by the coolant passages 46 is in contact with the coolant passages 46 above and below.

Also, as illustrated in FIG. 1, the coolant passage 46 includes a bypass passage 52 that bypasses the vehicle-side heat-generating apparatus 14 and the radiator 44, and delivers the coolant to the water heater 50. The bypass passage 52 includes a valve 54 that controls the rate of coolant flowing into the water heater 50 via the bypass passage 52.

The coolant passage 46 is provided with a pump 56 that sends coolant to the upstream side of the water heater 50. Note that the pump 56 may be integrated with the water heater 50.

Also, the coolant passage 46 is provided with a water temperature sensor 58 on the downstream side of the water heater 50 and before the heater core 30. The water temperature sensor 58 measures the temperature of the coolant. The water heater 50 controls the amount of heating by the PTC element 72 on the basis of the temperature of the coolant measured by the water temperature sensor 58. Note that the water temperature sensor 58 may be installed within the water heater 50.

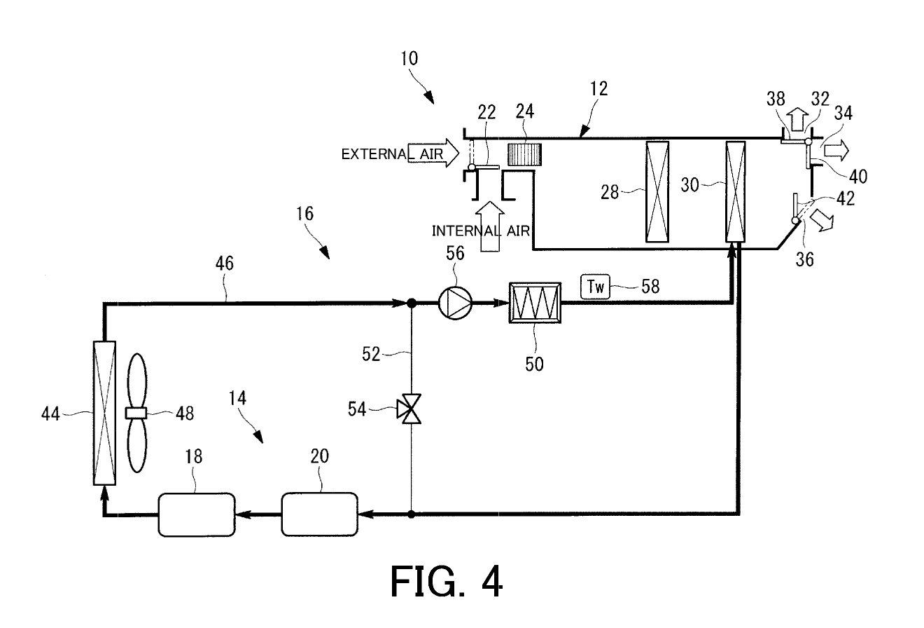

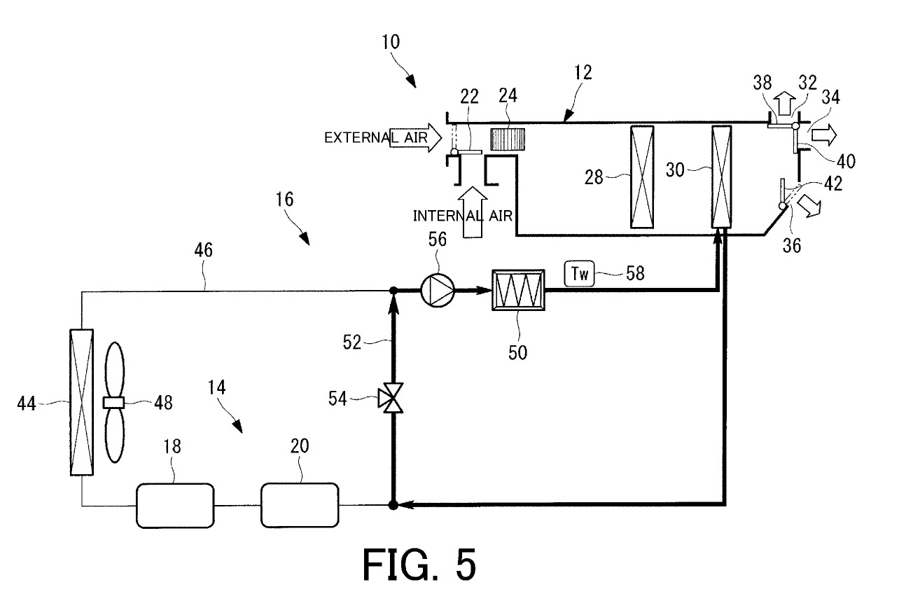

Next, the flow of the coolant during operation of the vehicle air-conditioning device 10 according to the present embodiment is described using FIGS. 4 and 5. Note that in each of these drawings, the passage of the refrigerant flow during operation is indicated by a thick line.

### Normal Heating Operation

FIG. 4 illustrates the flow of coolant during normal heating operation in which the valve 54 is in the closed state.

As illustrated in FIG. 4, the coolant is circulated between the heater core 30 and the radiator 44. In other words, after cooling the vehicle-side heat-generating apparatus 14, the heat of the coolant is dissipated in the radiator 44, and then is introduced to the heater core 30.

In other words, the coolant that flows to the heater core 30 is heated by the water heater 50. The water heater 50 is integrated with the air-conditioning power element 70 that is formed of a semiconductor element with high heat resistance, and the coolant is heated by the power element 70 and the PTC element 72. By forming the power element 70 using a semiconductor element with high heat resistance, the power element 70 has resistance to the coolant that is heated to a high temperature by cooling the engine 18, and can heat the coolant by the heat generated by the semiconductor element with high heat resistance itself. Also, the semiconductor element with high heat resistance, in other words the power element 70, is cooled by the coolant as the coolant is heated.

In this way, by providing the heater core 30 and the water heater 50 in the cooling system 16 of the vehicle-side heat-generating apparatus 14 in the vehicle air-conditioning device 10 according to the present embodiment, the cooling system 16 and the configuration of the heating and air-conditioning are integrated.

Therefore, in the vehicle air-conditioning device 10 according to the present embodiment, cooling of the air-conditioning power element 70 is carried out by the cooling system 16 of the vehicle-side heat-generating apparatus 14, and the heat thereof is used for heating air conditioning.

Also, the air-conditioning power element 70 and the PTC element 72 are integrated to form the water heater 50. Therefore, the electrical power of the PTC element 72 necessary to heat the coolant is reduced compared with the conventional technology, and the load on the PTC element 72 is reduced, so the reliability of the water heater 50 is increased. On the other hand, the PTC element 72 supplements the amount of heating which is insufficient with the air-conditioning power element 70 alone, so there is always sufficient heating for the coolant. In this way, the air-conditioning power element 70 and the PTC element 72 complement each other, so the water heater 50 can more efficiently heat the coolant.

Also, the power element 70 is formed of a semiconductor element with high heat resistance, so the cooling temperature of the power element 70 can be increased compared with the conventional technology. Therefore, the size of the radiator 44 can be reduced, and the input from the vehicle cabin exterior fan 48 to the radiator 44 can be reduced.

Also, the water heater 50 heats the coolant whose heat has been dissipated in the radiator 44 before it flows to the heater core 30. Therefore, control of the temperature of the coolant is simplified, and control of the temperature of the cabin heating is easy.

Therefore, the vehicle air-conditioning device 10 according to the present embodiment integrates the vehicle cooling system 16 and the configuration of the heating air conditioning, to enable more efficient heating air conditioning.

Also, by using the water heater 50, heating is enabled even when the external air temperature is low and the engine 18 is stopped. Therefore, it is not necessary to operate the engine 18 just for heating the vehicle cabin, so the fuel economy is improved.

In addition, by using the coolant that has been heated by the water heater 50 when starting the engine 18 when the external temperature is low, the fuel economy is improved.

### Bypass Heating Operation

FIG. 5 illustrates the flow of coolant during bypass heating operation in which the valve 54 is in the open state.

Opening the valve 54 allows the coolant to bypass the vehicle-side heat-generating apparatus 14 and the radiator 44 through the bypass passage 52 and to flow to the water heater 50.

When bypassing the radiator 44, the temperature of the radiator or the vehicle-side heat-generating apparatus 14 is low as is the case before the engine 18 is started, for example. In such a case, if the coolant is heated by the water heater 50 without bypassing the radiator 44, the amount of heating of the coolant necessary for heating is large, and start-up of the heating is slow.

On the other hand, if the coolant is heated by the water heater 50 without bypassing the radiator 44, the amount of heating of the coolant necessary for heating is small, and start-up of the heating is fast.

In this way, bypassing the radiator 44 and heating the coolant with the water heater 50 causes the temperature of the coolant to be raised in a short period of time, and this coolant flows to the heater core 30 in priority, so the start-up performance of the heating is improved.

As described above, the vehicle air-conditioning device 10 according to the present embodiment includes the water heater 50 in which the coolant flows so as to be circulated between the radiator 44 and the heater core 30 and which is integrated with the air-conditioning power element 70 formed of a semiconductor element with high heat resistance and causes the power element 70 and the heat-generating body to heat the coolant flowing to the heater core 30.

Therefore, the vehicle air-conditioning device 10 according to the present embodiment integrates the vehicle cooling system 16 and the configuration of the heating air conditioning, to enable more efficient heating air conditioning.

### First Modified Example

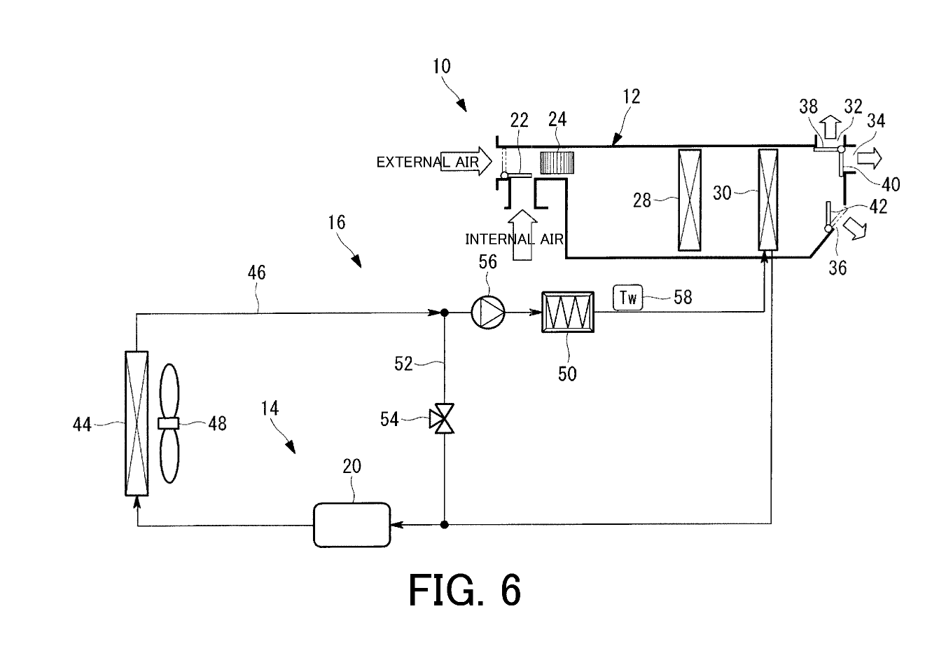

FIG. 6 illustrates the configuration of a first modified example of the vehicle air conditioning device 10. Note that in FIG. 6, constituent parts that are the same as in FIG. 1 are given the same reference signs as in FIG. 1, and their description is omitted.

The vehicle air-conditioning device 10 according to the first modified example is mounted in an electric vehicle (EV). Therefore, the engine 18 that is an internal combustion engine is not included as the vehicle-side heat-generating apparatus 14.

### Second Modified Example

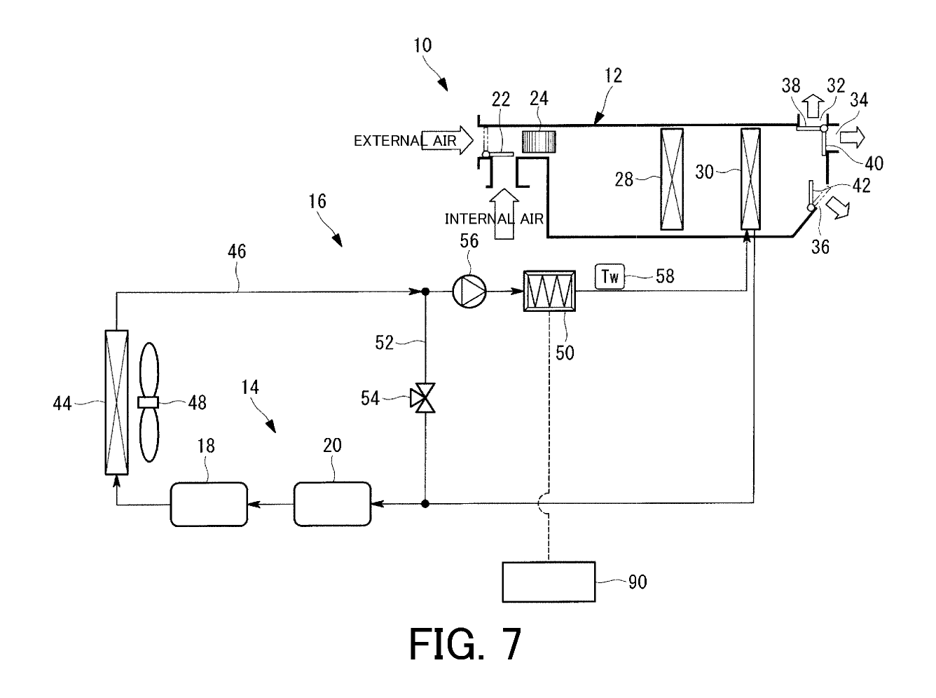

FIG. 7 illustrates the configuration of a second modified example of the vehicle air conditioning device 10. Note that in FIG. 7, constituent parts that are the same as in FIG. 1 are given the same reference signs as in FIG. 1, and their description is omitted.

In the second modified example, the water heater 50 can be operated with electric power from an electrical power source outside the vehicle (hereafter, referred to as “external electrical power source”). For example, when the vehicle is connected to an external power source 90, such as during charging of the vehicle, the water heater 50 is operated by the external power source 90.

Also, when the vehicle is connected to the external power source 90, wireless control of the water heater 50 can be carried out using a mobile terminal device or the like. Also, operation of the water heater 50 can be carried out by setting a timer.

In this way, when the external air temperature is low during, for example, early morning, and heating the vehicle cabin can be carried out with the water heater 50 in advance before a person enters the vehicle, thereby improving the comfort of the occupant.

In the above, the present invention has been described using the above embodiments, but the technical scope of the present invention is not limited to the scope of the embodiments as described above. Various modifications and improvements can be made to the above embodiments within a range that does not depart from the intention of the invention, and those modified or improved forms are also within the technical scope of the present invention.

### REFERENCE SIGNS LIST

10 Vehicle air-conditioning device

14 Vehicle-side heat-generating apparatus

30 Heater core

44 Radiator

46 Coolant passage

50 Water heater

52 Bypass passage

70 Power element

72 PTC element

1. A vehicle air-conditioning device comprising:
a radiator used for cooling a vehicle-side heat-generating apparatus;
a heater core that exchanges heat between air that is to be blown into a vehicle cabin and a heating medium;
a passage through which the heating medium flows so as to be circulated between the radiator and the heater core; and
a heater integrated with a power element for air conditioning formed of a semiconductor element with high heat resistance, the heater being configured to cause the power element and a heat-generating body to heat the heating medium that flows to the heater core.

2. The vehicle air-conditioning device according to claim 1, wherein the passage includes a bypass passage that causes the heating medium to bypass the vehicle-side heat-generating apparatus and the radiator and to be delivered to the heater.

3. The vehicle air-conditioning device according to claim 1, wherein the heater heats the heating medium whose heat has been dissipated in the radiator, before the heating medium is delivered to the heater core.

4. The vehicle air-conditioning device according to claim 1, wherein the heater is operable by electrical power from an electrical power source that is external to the vehicle.

5. A vehicle air-conditioning heater comprising:
a heat-generating body; and
an air-conditioning power element formed of a semiconductor element with high heat resistance;
the heat-generating body and the power element are disposed facing each other and in contact with a passage through which a heating medium for heating air-conditioning flows.

6. An air-conditioning method for a vehicle that includes a radiator used for cooling a vehicle-side heat-generating apparatus, a heater core that exchanges heat between air to be blown into a vehicle cabin and a heating medium, and a passage through which the heating medium flows so as to be circulated between the radiator and the heater core, the method comprising the step of:
heating the heating medium flowing to the heater core by a power element for air conditioning formed of a semiconductor element with high heat resistance and a heat-generating body.

7. The vehicle air-conditioning device according to claim 2, wherein the heater heats the heating medium whose heat has been dissipated in the radiator, before the heating medium is delivered to the heater core.

8. The vehicle air-conditioning device according to claim 2, wherein the heater is operable by electrical power from an electrical power source that is external to the vehicle.

9. The vehicle air-conditioning device according to claim 3, wherein the heater is operable by electrical power from an electrical power source that is external to the vehicle.
